(19) United States
(12) Patent Application Publication
(10) Pub. No.: US 2024/0028799 A1
(43) Pub. Date: Jan. 25, 2024

(54) METHOD OF PREDICTING WIND BEHAVIOR

(71) Applicant: Andrew Walter Werner, CHANHASSEN, MN (US)

(72) Inventor: Andrew Walter Werner, CHANHASSEN, MN (US)

(21) Appl. No.: 17/813,423

(22) Filed: Jul. 19, 2022

(51) Int. Cl. G06F 30/28; G01W 1/10

(52) U.S. Cl. CPC G06F 30/28; G01W 1/10

(57) ABSTRACT

A method of determining an effect of wind on a flight path of a golf ball includes predictive modeling a flow of air through a null terrain with a processing system. The null terrain includes a three-dimensional digital model of a physical terrain and a physical feature. Changes of a wind speed, a wind direction, or a combination thereof of the flow of air are calculated with the processing system based on the predictive modeling of the wind speed and the wind direction through the null terrain. An output data set of predicted wind behavior is generated based on the calculated changes of wind speed, wind direction, or a combination thereof of the flow of air through the null terrain. An effect of wind behavior on the flight-path of the golf ball is predicted based on the output data set of predicted wind behavior.

### BACKGROUND

The present disclosure generally relates to predicting wind effects. In particular, the present disclosure relates to predicting a behavior of wind and effects of the wind on a golf ball.

While golfing, it is often difficult for a golfer to accurately predict how wind will affect their golf ball while the ball is in the air. Features of the surrounding physical terrain can affect the wind in ways that are not immediately apparent to the golfer before or at the time he/she hits their golf shot. This can often lead to golf balls ending up in a different destination than intended (e.g., rough, bunker, penalty area, out of bounds, etc.).

Existing wind gauges (e.g., anemometers) are able to measure a speed and direction of wind at a specific location. However, the Rules of Golf provide that you may not use a device to take measurements or gauge wind speed and direction.

### SUMMARY

A method of predicting wind behavior across a physical terrain includes scanning an area of the physical terrain with a sensor. A contour of the physical terrain is detected with the sensor. A presence of a physical feature on the physical terrain is detected with the sensor. A first data set representative of the physical terrain with the physical feature is created with a processing system based on the scanned area and the detected contour of the physical terrain. The first data set is converted into a null terrain. The null terrain includes a three-dimensional digital model of the physical terrain and a three-dimensional digital model of the physical feature. A flow of air through the null terrain is predictively modelled with the processing system. The flow of air includes a wind speed and a wind direction. Changes of the wind speed, the wind direction, or a combination thereof of the flow of air is calculated with the processing system based on the predictive modeling of the wind speed and the wind direction through the null terrain. An output data set of predicted wind behavior is generated based on the calculated changes of wind speed, wind direction, or a combination thereof of the flow of air through the null terrain.

A method of predicting effects of wind on a golf ball includes creating a three-dimensional model of a terrain that includes a physical feature. A wind speed, a wind direction or a combination thereof of an airflow is predictively modelled with a processing system onto the three-dimensional model of the terrain. The three-dimensional model of the terrain includes a three-dimensional model of the physical feature. The predictive modelling includes simulating a flow path of the airflow flowing through the three-dimensional model of the terrain and determining an amount of change in the simulated flow path of the airflow caused by the three-dimensional model of the physical feature. A flight path of the golf ball in the three-dimensional model of the terrain is simulated based on the determined amount of change in the simulated flow path of the airflow. A change in the flight path of the golf ball in response to the simulated flow path of the airflow through the three-dimensional model of the terrain is simulated. A data set representative of the change in the flight path of the golf ball is output.

A method of determining an effect of wind on a flight path of a golf ball includes predictive modeling a flow of air through a null terrain with a processing system. The null terrain includes a three-dimensional digital model of a physical terrain and a three-dimensional digital model of a physical feature. Changes of a wind speed, a wind direction, or a combination thereof of the flow of air are calculated with the processing system based on the predictive modeling of the wind speed and the wind direction through the null terrain. An output data set of predicted wind behavior is generated based on the calculated changes of wind speed, wind direction, or a combination thereof of the flow of air through the null terrain. An effect of wind behavior on the flight-path of the golf ball is predicted based on the output data set of predicted wind behavior. The effect of the wind on the flight path of the golf ball is calculated with the processing system.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a flowchart illustrating a first group of steps of a method of predicting wind behavior across a physical terrain.

FIG. 2 is a flowchart illustrating a second group of steps of the method of predicting wind behavior across a physical terrain.

FIG. 3 is a flowchart illustrating a third group of steps of the method of predicting wind behavior across a physical terrain.

FIG. 4 is a flowchart illustrating a fourth group of steps of the method of predicting wind behavior across a physical terrain.

FIG. 5 is a flowchart illustrating a first group of steps of a method of predicting effects of wind on a golf ball.

FIG. 6 is a flowchart illustrating a second group of steps of the method of predicting effects of wind on a golf ball.

FIG. 7 is an overhead view of a golf hole shown with wind blowing thereacross.

FIG. 8 is a perspective down the line view of another golf hole with a golfer preparing to hit a golf shot.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

It is likely that a golfer is unfamiliar with every type of wind behavior for any given golf shot that they face during a round of golf. For example, it is likely that a golfer is unable to predict the behavior of wind everywhere on a golf course and how such wind behavior will affect the flight of their golf ball during shots everywhere on the golf course. For example, even if a player plays one or more rounds of golf on a given course, the wind conditions during those rounds may be limited to certain directions or certain velocities. This potentially leads to a situation of being faced with an unknown wind condition during a competitive round of golf where the golfer has not yet experienced a particular set of wind conditions with a particular direction and a particular velocity.

The effects of wind on a golf shot can be predicted based on how the physical features (e.g., trees, elevation changes, etc.) on the golf course impact flow fields of wind as wind passes across those physical features. For example, the physical features of the golf course are entered into a three-dimensional model which is then subjected to a computational fluid dynamics analysis in order to determine how wind behaves (in three-dimensions) in response to those physical features. The determined wind behavior is then applied to a modelled flight of a golf shot to determine how the wind will affect a particular type of shot of a particular player.

The disclosed method gives a golfer access to calculated determinations of how the wind will affect the flight of their golf ball over any range of wind velocities and any range of wind directions, as well as over a range of shot types, club selection, and given conditions. This allows golfers to know how the wind will affect their specific shot on a specific hole given all of the specific conditions of and during said shot.

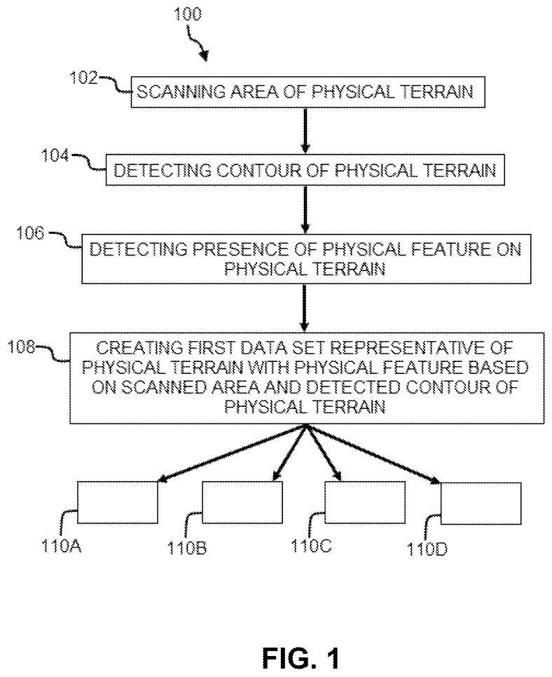

Referring now to FIG. 1, FIG. 1 is a flowchart showing steps 102-110D of method 100 for predicting wind behavior across a physical terrain (e.g., an area of land).

As shown by reference number 102, an area of the physical terrain may be scanned. The area of the physical terrain may be scanned with a sensor. In such an exemplary embodiment, the sensor may include one or more of an optical camera sensor, a radio detection and ranging (“RADAR”) sensor, a light detection and ranging (“LIDAR”) sensor, or any combination thereof and may be mounted on any of a ground based device, a drone, a kite, a balloon, a blimp, a helicopter, an airplane, a satellite, or other known aerial device.

As shown by reference number 104, a contour of the physical terrain may be detected with the sensor. The contour of the physical terrain may include hills, valleys, ravines, mountains, cliffs, or other geological formations.

As shown by reference number 106, a presence of a physical feature on the physical terrain may be detected. The physical feature is an identifiable surface feature (or features) and may include a permanent man-made structure (e.g., building), a temporary man-made structure (e.g., bleacher, tent, pavilion, TV tower, etc.), a natural structure (e.g., hill, mountain, cliff, bank, or other sharp elevation changes), a crowd of people, a fountain, a tree, a forest, a body of water (e.g., stream, river, lake, pond etc.), or any combination thereof. In one exemplary embodiment the sensor used in step 106 may be the same sensor used in step 104. In another exemplary embodiment, the sensor used in step 106 may be a different type of sensor than the sensor used in step 104.

As shown by reference number 108, a first data set representative of the physical terrain with the physical feature may be created with a processing system based on the scanned area, on the detected contour of the physical terrain, or on a combination thereof. In certain exemplary embodiments, the processing system may include a computer, a super computer, a hard drive, a computer program, a web-based application, or any combination thereof.

In certain exemplary embodiments, the first data set representative of the physical terrain with the physical feature may be created with the use of a passive sensor methodology (e.g., aerial photography, satellite imagery), photogrammetry, an active sensor methodology (e.g., satellite RADAR mapping, LIDAR), or a combination thereof.

In an embodiment, step 108 may additionally or alternatively include adding data to the data set that is representative of one or more physical features that were not scanned, not detected, or a combination thereof during the previous steps. For example, a user may manually or automatically enter data into the data set that is representative of a physical feature or man-made structure that is not currently present or does not currently exist on or in the physical terrain, but that the user wants to account for in predicting wind behavior. An example of this may be data representative of bleachers, stands, people, trees, or other natural or man-made structures not currently present in the physical terrain, but that may be present in the physical terrain at some time (e.g., in the future, or in the past).

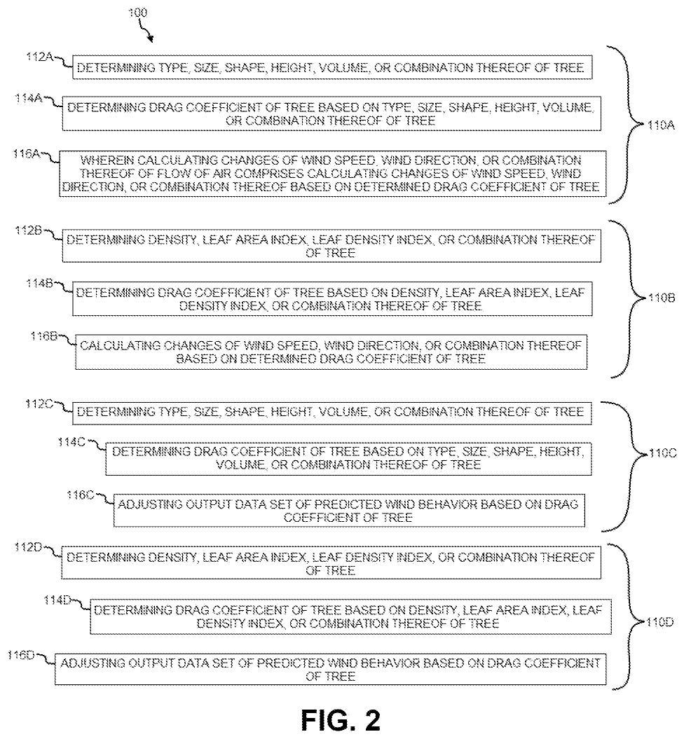

Method 100 may include step 110A, 100B, 110C or 110D, each of which are discussed further with respect to FIG. 2.

Referring now to FIG. 2, FIG. 2 is a flowchart illustrating steps 110A, 100B, 110C or 110D of method 100 of predicting wind behavior across a physical terrain. In each of steps 110A, 110B, 110C, and 110D, the physical feature may include a tree. As used herein, the term “tree” can be used to refer to one or more trees (e.g., a forest), bushes, or other plants.

Steps, components, arrangements of the components, or a combination thereof involved with method 100 shown in FIG. 2 may be configured in a similar manner to steps, components, arrangements of the components, or a combination thereof involved with method 100 described above with reference to FIG. 1. Accordingly, the same or similar numbers of FIGS. 1 and 2 may refer to same or similar steps or parts. Likewise, the same or similar numbers amongst any or all figures may refer to same or similar steps or parts.

Step 110A includes steps 112A-116A. As shown by reference number 112A, a type, a size, a shape, a height, a volume, or a combination thereof of the tree can be determined. In an embodiment, a type of the tree or trees may include deciduous, evergreen, or a combination thereof. In another embodiment, the shape of the tree may be defined by a shape of a canopy of the tree such as spherical, conical, columnar, oval, open, weeping, pyramidal, vase, umbrella, irregular, or a combination thereof.

As shown by reference number 114A, a drag coefficient of the tree can be determined based on the type, the size, the shape, the height, the volume, or the combination thereof of the tree. In an exemplary embodiment, the first data set may include the drag coefficient of the tree.

As shown by reference number 116A, the changes of the wind speed, the wind direction, or the combination thereof of the flow of air can be calculated based on the determined drag coefficient of the tree.

Step 110B includes steps 112B-114B. As shown by reference number 112B, a density, a leaf area index, a leaf density index, or a combination thereof of the tree can be determined. In an embodiment, the leaf density index (or value) may be determined based on an identified type of canopy shape (e.g., spherical, conical, columnar, oval, open, weeping, pyramidal, vase, umbrella, irregular, or a combination thereof).

As shown by reference number 114B, a drag coefficient of the tree based on the density, the leaf area index, the leaf density index, or the combination thereof of the tree can be determined. In an embodiment, the first data set may comprise the drag coefficient of the tree. As shown by reference number 116B, calculating the changes of the wind speed, the wind direction, or the combination thereof of the flow of air may comprise calculating the changes of the wind speed, the wind direction, or the combination thereof based on the determined drag coefficient of the tree.

Step 110C includes steps 112C-116C. As shown by reference number 112C, a type, a size, a shape, a height, a volume, or a combination thereof of the tree can be determined. In an embodiment, calculating changes of the wind speed, the wind direction, or a combination thereof of the flow of air may comprise steps 114C-116C. As shown by reference number 114C, a drag coefficient of the tree based on the type, the size, the shape, the height, the volume, or the combination thereof of the tree cam be determined. As shown by reference number 116C, the output data set of predicted wind behavior can be adjusted based on the drag coefficient of the tree.

Step 110D includes steps 112D-116D. As shown by reference number 112D, a density, a leaf area index, a leaf density index, or a combination thereof of the tree can be determined. In an embodiment, calculating changes of the wind speed, the wind direction, or a combination thereof of the flow of air may comprise steps 114D-116D. As shown by reference number 114D, a drag coefficient of the tree based on the density, the leaf area index, the leaf density index, or the combination thereof of the tree can be determined. As shown by reference number 116D, the output data set of predicted wind behavior based on the drag coefficient of the tree can be adjusted.

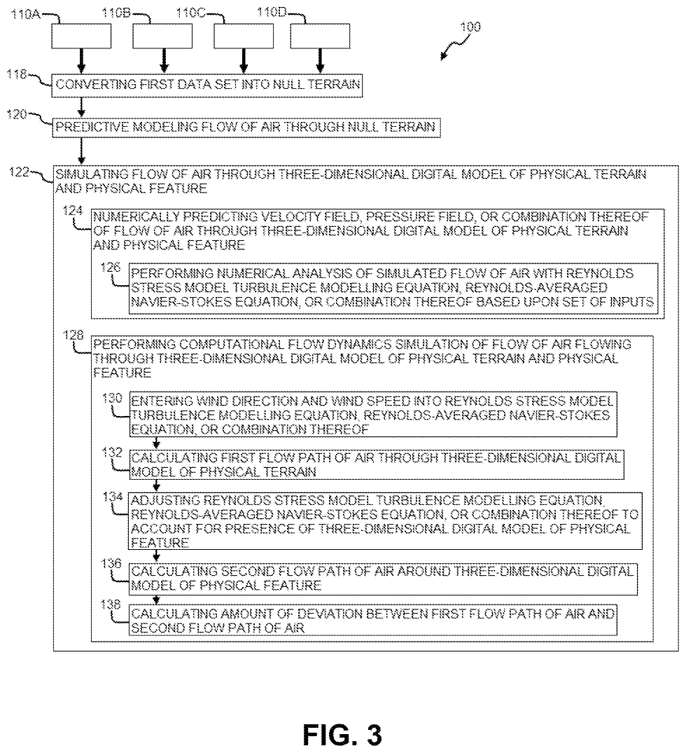

Referring now to FIG. 3, FIG. 3 is a flowchart illustrating steps 118-138 of method 100 of predicting wind behavior across a physical terrain.

As shown by reference number 118, the first data set can be converted into a null terrain with the processing system. In an embodiment, the null terrain may comprise a three-dimensional digital model of the physical terrain a three-dimensional digital model of the physical feature, or a combination thereof. Additionally, or alternatively, the null terrain may comprise a three dimensional topographical map of an area of land.

As shown by reference number 120, a flow of air through the null terrain can be predictively modeled with the processing system. In an embodiment, the flow of air can include a wind speed, a wind direction, or a combination thereof. In an embodiment, the flow of air through the null terrain can be predictively modeled based on a set of inputs comprising air temperature, air pressure, elevation, air density, air quality, barometric pressure, humidity, other ambient characteristics such as the presence of fog, rain, sleet, snow, or any combination thereof.

As shown by reference number 122, the flow of air through the three-dimensional digital model of the physical terrain and the physical feature can be simulated. In an embodiment, step 122 can also include steps 124-138. As shown by reference number 124, a velocity field, a pressure field, or a combination thereof of the flow of air through the three-dimensional digital model of the physical terrain and the physical feature can be numerically predicted. Step 124 may also include step 126.

As shown by reference number 126, a numerical analysis of the simulated flow of air with a Reynolds stress model turbulence modelling equation, a reynolds-averaged navier-stokes equation, or a combination thereof can be performed based upon a set of inputs. In an embodiment, the set of inputs may comprise a temperature, a barometric pressure, a density, a humidity, a viscosity, or a combination thereof of the air and any of which may be based upon a weather forecast, upon measured values of one or more of the inputs at a given time (e.g., past or present), or upon a combination thereof.

As shown by reference number 128, a computational flow dynamics simulation of the flow of air flowing through the three-dimensional digital model of the physical terrain and the physical feature. Step 130 may also include steps 130-138.

As shown by reference number 130, the wind direction and the wind speed can be entered into a Reynolds stress model turbulence modelling equation, a reynolds-averaged navier-stokes equation, or a combination thereof. As shown by reference number 132, a first flow path of air through the three-dimensional digital model of the physical terrain can be calculated with the processing system.

As shown by reference number 134, the Reynolds stress model turbulence modelling equation, the reynolds-averaged navier-stokes equation, or the combination thereof can be adjusted to account for the presence of the three-dimensional digital model of the physical feature. As shown by reference number 136, a second flow path of air around the three-dimensional digital model of the physical feature can be calculated. As shown by reference number 138, an amount of deviation between the first flow path of air and the second flow path of air can be calculated by the processing system.

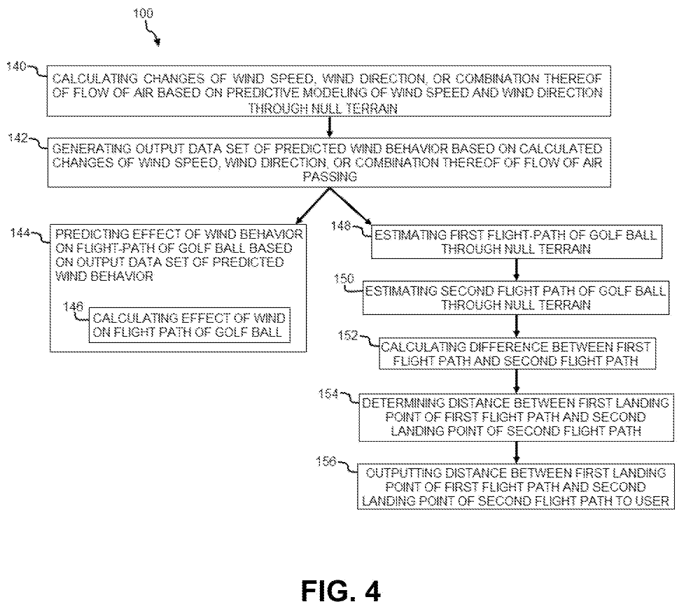

Referring now to FIG. 4, FIG. 4 is a flowchart illustrating steps 140-156 of method 100 of predicting wind behavior across a physical terrain.

As shown by reference number 140, changes of the wind speed, the wind direction, or a combination thereof of the flow of air can be calculated based on the predictive modeling of the wind speed and the wind direction through the null terrain.

As shown by reference number 142, an output data set of predicted wind behavior can be generated based on the calculated changes of wind speed, wind direction, or a combination thereof of the flow of air passing. In an embodiment, the output data set of predicted wind behavior can be additionally, or alternatively, generated based on variables such as temperature, humidity level, dew point, elevation, air density, time of day, or a combination thereof.

In an embodiment, one of either step 144 or step 148 may follow after step 142 in method 100.

As shown by reference number 144, an effect of wind behavior on a flight-path of a golf ball can be predicted based on the output data set of predicted wind behavior. In an embodiment, step 144 may include step 146. As shown by reference number 146, the effect of the wind on the flight path of the golf ball can be calculated.

As shown by reference number 148, a first flight-path of the golf ball through the null terrain can be estimated. The first flight-path of the golf ball may include a first starting point, a first landing point, or a combination thereof. The first flight path of the golf ball may be estimated without an effect of wind on the golf ball.

As shown by reference number 150, a second flight path of the golf ball through the null terrain can be estimated. The second flight path may include a second starting point, a second landing point, or a combination thereof. The second flight path of the golf ball may be estimated with an effect of wind on the golf ball. As shown by reference number 152, a difference between the first flight path and the second flight path can be calculated. As shown by reference number 154, a distance between the first landing point of the first flight path and the second landing point of the second flight path can be determined.

As shown by reference number 156, the distance between the first landing point of the first flight path and the second landing point of the second flight path to can be outputted or communicated to a user. As used herein, the term “user” may be used interchangeably with terms such as golfer, player, shot maker, and person. For example, information can be presented to the user based on the distance between the first landing point of the first flight path and the second landing point of the second flight path that indicates a predicted wind speed and direction. Such information may then be used by the user to inform their selection of shot type, club, ball, swing speed, swing path, or a combination thereof.

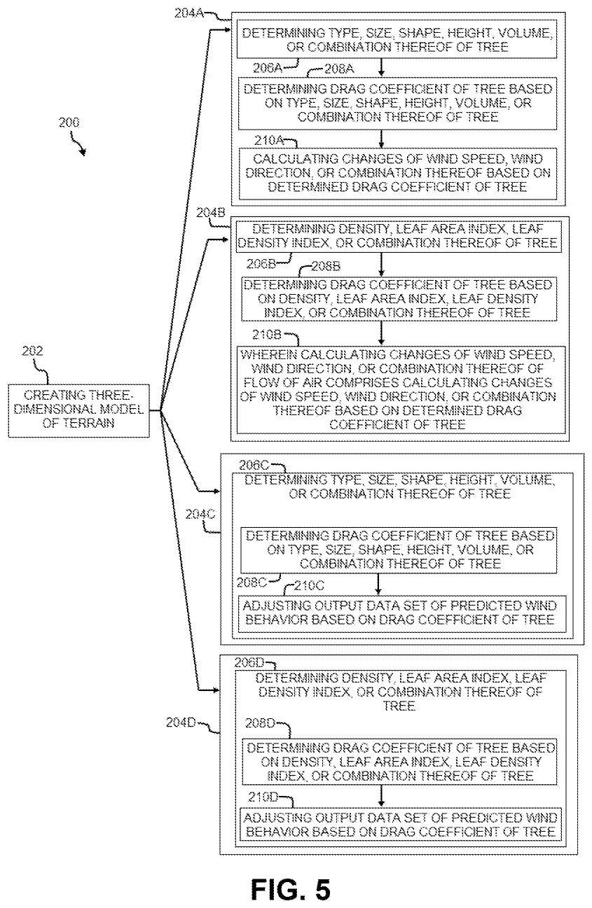

Referring now to FIG. 5, FIG. 5 is a flowchart illustrating steps 202-210D of method 200 of predicting effects of wind on a golf ball. In an embodiment, any one of steps 202-234 may be performed by one or more of a processing system.

As shown by reference number 202, a three-dimensional model of a terrain can be created, e.g., by a processing system. In an embodiment, the terrain may comprise a physical feature. In an embodiment, one of steps 204A, 204B, 204C, and 204D may follow after step 202 in method 200. In one or more of steps 204A, 204B, 204C, and 204D, the physical feature may comprise a tree.

Step 204A can include steps 206A-210A. As shown by reference number 206A, a type, a size, a shape, a height, a volume, or a combination thereof of the tree can be determined. As shown by reference number 208A, a drag coefficient of the tree based on the type, the size, the shape, the height, the volume, or the combination thereof of the tree can be determined. As shown by reference number 210A, calculating the changes of the wind speed, the wind direction, or the combination thereof of the flow of air may comprise calculating the changes of the wind speed, the wind direction, or the combination thereof based on the determined drag coefficient of the tree.

Step 204B can include steps 206B-210B. As shown by reference number 206B, a density, a leaf area index, a leaf density index, or a combination thereof of the tree can be determined. As shown by reference number 208B, a drag coefficient of the tree based on the density, the leaf area index, the leaf density index, or the combination thereof of the tree can be determined. As shown by reference number 210B, calculating the changes of the wind speed, the wind direction, or the combination thereof of the flow of air comprises calculating the changes of the wind speed, the wind direction, or the combination thereof based on the determined drag coefficient of the tree.

Step 204C can include steps 206C-210C.

As shown by reference number 206C, a type, a size, a shape, a height, a volume, or a combination thereof of the tree can be determined.

As shown by reference number 208C, a drag coefficient of the tree based on the type, the size, the shape, the height, the volume, or the combination thereof of the tree can be determined.

As shown by reference number 210C, the output data set of predicted wind behavior based on the drag coefficient of the tree can be adjusted.

Step 204D can include steps 206D-210D.

As shown by reference number 206D, a density, a leaf area index, a leaf density index, or a combination thereof of the tree can be determined.

As shown by reference number 208D, a drag coefficient of the tree based on the density, the leaf area index, the leaf density index, or the combination thereof of the tree can be determined.

As shown by reference number 210D, the output data set of predicted wind behavior based on the drag coefficient of the tree can be adjusted.

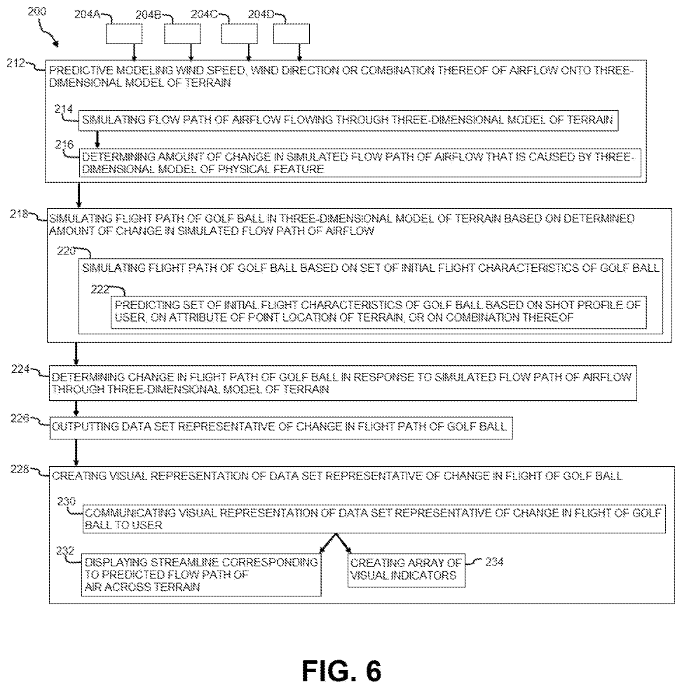

Referring now to FIG. 6, FIG. 6 is a flowchart illustrating steps 212-234 of method 200 of predicting effects of wind on a golf ball.

As shown by reference number 212, a wind speed, a wind direction or a combination thereof of an airflow can be predictively modelled onto the three-dimensional model of the terrain. In an embodiment, the three-dimensional model of the terrain may comprise a three-dimensional model of the physical feature.

Step 212 may also include steps 214-216

As shown by reference number 214, a flow path of the airflow flowing through the three-dimensional model of the terrain can be simulated.

As shown by reference number 216, an amount of change in the simulated flow path of the airflow that is caused by the three-dimensional model of the physical feature can be determined.

As shown by reference number 218, a flight path of a golf ball in the three-dimensional model of the terrain can be simulated based on the determined amount of change in the simulated flow path of the airflow.

Step 218 may also include steps 220-222.

As shown by reference number 220, the flight path of the golf ball can be simulated based on a set of initial flight characteristics of the golf ball.

Step 220 may also include step 222.

As shown by reference number 222, the set of initial flight characteristics of the golf ball can be predicted based on a shot profile of a user, on an attribute of a point location of the terrain, or on a combination thereof. In an embodiment, the shot profile of the user can be specific to a particular golfer. For example, the shot profile of the user can be based on a data set including, on a per club basis, average launch angle of a shot, initial and variable spin rates of the golf ball at the beginning of and during a shot (e.g., back spin, side spin), spin axis, average impact location on the clubface of the ball during impact, the coefficient of restitution of specific clubs, a weight of the club or clubhead, swing speed, clubhead speed during a shot, average club face orientation (e.g., face angle, loft, effective loft), attack angle (e.g., relative to ground level), club path, swing plane, swing arc length, swing curvature, vertical angle of descent of the swing, degree of inside-to-outside swing path, degree of outside-to-inside swing path, low point of swing, swing direction, ball speed, launch angle, launch direction, or a combination thereof. In an embodiment, the clubhead speed of a golf club swung by the user may comprise a set of clubhead speed values, with each clubhead speed value of the set of clubhead speed values being associated with a different golf club (with different clubs being distinguished by at least one of a different club face loft and a different length. In another embodiment, the launch angle of the golf ball may comprise a set of launch angle values, with each launch angle value of the set of launch values being associated with a different golf club. In yet another embodiment, the swing speed of the user comprises a set of swing speed values, with each swing speed value of the set of swing speed values being associated with a different golf club, a different type of swing, or a combination thereof.

Additionally, or alternatively, the shot profile of the user can be based on aspects of the golf ball used by the user. For example, a type of golf ball (e.g., type, brand, model, age, physical condition, or combination thereof of the golf ball) may include a certain set of performance characteristics such as dimple pattern, aerodynamic profile, amount of spin per club, weight, size, spherical symmetry, initial velocity, overall distance standard, or a combination thereof.

In another embodiment, the attribute of the point location of the terrain (e.g., the location of the golf ball on the terrain) may include an amount of slope of the point location, type of grass, length of grass, density of grass (e.g., blades per area), amount of moisture on the grass, ground condition type (e.g., grass, dirt, sand, straw, pine needles, etc.), angle of grass relative to direction of intended golf shot, dew point, humidity of surrounding air, temperature, elevation, or a combination thereof.

As shown by reference number 224, a change in the flight path of the golf ball can be determined in response to the simulated flow path of the airflow through the three-dimensional model of the terrain.

As shown by reference number 226, a data set representative of the change in the flight path of the golf ball can be output.

As shown by reference number 228, a visual representation of the data set representative of the change in the flight of the golf ball can be created.

Step 228 may also include steps 230-234.

As shown by reference number 230, the visual representation of the data set representative of the change in the flight of the golf ball can be communicated to a user for the user to then use in estimating the wind effects on the ball.

In an embodiment, the visual representation of the data set representative of the change in the flight of the golf ball can be communicated to the user with an identifier on a physical item such as a printed piece of paper (e.g., similar to a yardage book or a green-reading book). In such an example, the predicted impact of the wind can correspond to a marking on a read-out or print-out that is based on the magnitude and direction of variability of the wind. In another example, the read-out or print-out can include a two-dimensional or three-dimensional representation of a portion of the terrain (e.g., of the golf course) and may incorporate a grid with vertical, side-to-side, or a combination thereof of identifiers. Additionally, or alternatively, the visual representation of the data set representative of the change in the flight of the golf ball can be a two-dimensional map of a golf course or a hole on the golf course with an over-lay of arrowheads with a direction and size of arrowheads relating to the predicted level of effect the wind will have on a given shot at certain times during the round.

In another embodiment, a read-out of estimated effects of a flight-path of a ball may be created based on forecasted conditions, based on time-of-day markers, based on hole-by-hole estimations in view of estimated times when the specific holes and shots would be played, or a combination thereof. Additionally, or alternatively, readings or markings may be provided based on multiple locations (on a read-out or print-out) per hole to account for the chances that the player hits their shot anywhere on the hole.

In yet another embodiment, predicted wind speed and direction and associated estimations of how the predicted wind speed and direction will affect the flight of a golf ball may be displayed with a manual wind speed indicator tool. In such an example, the manual wind speed indicator tool may include a wheel chart or a card wheel chart (e.g., a sort of spin-wheel device) configured to allow for a selection of wind speed and wind direction to produce a specific set of information outputs to the user, such as estimated distance and side-to-side variances in ball flight. In an embodiment, a calibration and readings on such a wheel chart can be determined based on forecasted, measured, or a combination thereof of conditions of a given location (e.g., hole), date, and time on a particular golf course.

In another embodiment, the visual representation of the data set representative of the change in the flight of the golf ball can be communicated to the user via electronic means, via live or real-time means, or a combination thereof. For example, predicted effects of wind on golf shot may be output onto a display with weighted arrowheads include a reading of MPH or KPH (e.g., with the term “weighted” referring to a thickness of the arrowheads, where a thickness and/or a length of the arrowheads can be used to indicated certain speeds of the wind or an amount of distance variance expected for a given golf shot). In another embodiment, a unit of distance can be displayed associated with a predicted amount of distance (e.g., yards or meters) the ball will deviate from its initial flight path due to the impact of the wind. In yet another embodiment, the processing system can triangulate a side-to-side variance or delta (e.g., distance variation due to magnitude of localized effective wind conditions), show an adjustment with a virtual aiming beacon, and provide an effective yardage value next to the virtual aiming beacon where the effective yardage takes into account the distance differential due to the localized effective wind conditions along the length of the shot.

In another embodiment, predicted wind speed and direction and associated estimations of how the predicted wind speed and direction will affect the flight of a golf ball may be displayed on a screen such as on a hand-held device (e.g., smart-phone, a GPS device, etc.), a device mounted or attached to a user's equipment bag (e.g., golf bag), a wearable device (e.g., smart-watch), a display (e.g., digital or analog) located in a butt-end of a grip of the golf club, or a combination thereof. In another embodiment, information may be communicated with an augmented display such as the information being overlaid onto a display of a monocular, rangefinder, binocular, glasses, digital contact lenses, or a combination thereof. In another embodiment, information may be communicated to the user by an audio device such as a speaker or a device located in, or, or near an ear of the user.

In contrast to relying on a general wind direction and wind speed to guesstimate of far the golf ball will veer one way or another based on a thought process of the user, effects of the wind can be determined anywhere on the golf course instantaneously based on the estimated, forecasted, or real-time measurement of conditions and based on the predictive modelling.

In an embodiment, either of step 232 or step 234 may follow step 230 in method 200.

As shown by reference number 232, a streamline corresponding to a predicted flow path of air across the terrain can be displayed. In an embodiment, a streamline can include a line depicting a flowpath of air or wind. In such an example, one or more streamlines may be displayed on a physical item such as a printed piece of paper or electronically.

As shown by reference number 234, an array of visual indicators can be created. In an embodiment, each indicator of the array of indicators may include a visual characteristic corresponding to a physical attribute of the airflow at a location in space. The physical attribute may include a direction, a speed, a velocity, or a combination thereof of the airflow. For example, the array of visual indicators may include an array of arrows, with the dimensions, color, direction, or a combination thereof depicting a direction and a magnitude of the air flow or wind.

In another embodiment, information can be displayed or provided to the user as a “multiplier value”, a value by which to multiply the current wind speed, multiply the amount of deviation of the shot due to the wind, or a combination thereof. For example, an estimated and/or calculated amount of acceleration (or deceleration) of the wind due to one or more physical features of the golf course.

In another embodiment, information can be communicated to the user and/or displayed as: a combined vector with single direction with a single multiplier value; as one lateral or side-to-side component (e.g., left-to-right component or right-to-left component) and a headwind/tailwind component; a vertical component representing an upward or a downward component of the wind (e.g., reflecting a presence of an updraft or a downdraft); or a combination thereof. In another example, an updraft component, a downdraft component, or a combination thereof can be shown with or built into the headwind/tailwind component. In such examples, an updraft component of the wind can be an upward (or outward) directed flow relative to a direction of elevation from the center of Earth pointing radially outward. Likewise, a downdraft component

Downward directed flow of the wind can be a downward (or inward) directed flow relative to the direction of elevation from the center of Earth pointing radially outward.

Additionally, or alternatively, one or both of methods 100 and 200 may include validating predicted wind characteristics by measuring actual wind behavior at specific locations of interest.

For example, wind measurements can be taken at various locations across a golf course and the surrounding area with one or more wind gauges or other wind measuring devices. Such measurements can include a variability of wind direction and speed. In another example, otherwise supplied data set(s) of wind characteristics such as direction, velocity, degree of variability, or a combination by another source (e.g., national weather data, etc.). One or more steps of method 100, method 200, or a combination thereof may then be executed to adjust the predicted wind values more in line with actual measured values of the wind.

Additionally, or alternatively, one or both of methods 100 and 200 may include periodically scanning the area of interest for changes to physical features that affect wind behavior. For example, the presence of new structures, tree growth, excavation, new course configuration, new trees, removed trees, temporary structures (e.g., tournament seating, tents, towers, etc.), or a combination thereof may be sensed and taken into account in order to predict a change in wind behavior, to predict effects of wind on a golf ball, or a combination thereof.

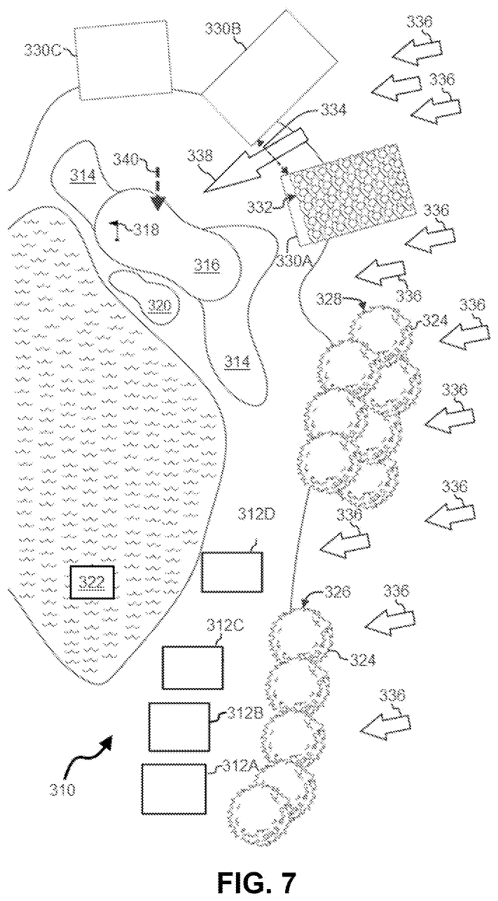

Referring now to FIG. 7, FIG. 7 is an overhead view of golf hole 310 shown with wind blowing across golf hole 310.

Golf hole 310 includes tee boxes 312A, 312B, 312C, and 312D. Tee boxes 312A, 312B, 312C, and 312D are portions of golf hole 310 where golfers are meant to hit their first shot on golf hole 310.

Golf hole 310 further includes fairway 314. Fairway 314 may include grass that is cut to a specific height (e.g., at a height less than a length of the grass in the rough of golf hole 310, and at a length that is longer than a length of grass of green 316). In this embodiment, there are two portions of fairway 314.

Golf hole 310 also includes green 316. Green 316 is an area of grass and is a portion of golf hole 310 that is the intended target area for a golf shot. Green 316 includes pin 318.

Pin 318 is pole with a flag attached to the top of the pole. In an embodiment, a hole is located in green 316 at the bottom of pin 318 and such that pin 318 rests in the hole in green 316.

In an embodiment, golf hole 310 may include bunker 320. Bunker 320 is an area of golf hole 310 that is filled with sand.

Golf hole 310 also includes water 322. Water 322 includes a body of water. In an embodiment, water 322 may include a man-made pond. In other embodiments, water 322 may include a natural pond, lake, ocean, steam, river, pool, marsh, or other area of water. In this embodiment, a portion of water 322 is located in close proximity to a portion of green 316. In this way, if a golfer were to hit a golf shot slightly to the left of green 316, the golf ball would be in danger of ending up in water 322. Additionally or alternatively, water 322 may include one or more fountains, islands, man-made objects, or other features.

Golf hole 310 also includes trees 324. Trees 324 may include any sort, type, or kind of trees or other plants. In this embodiment, trees 324 are shown in two separate groups—first group 326 and second group 328. In other embodiments, trees 324 may be in more or less groupings, as well as be a part of a larger grouping such as a forest. In yet other embodiments, trees 324 may include one or more sort, type, kind, size, age, or other characteristic of plants.

Golf hole 310 is shown to further include man-made objects 330. In this embodiment, man-made objects 330 may include first man-made object 330A, second man-made object 330N, and third man-made object 330C. Man-made objects 330 are objects constructed by a person and otherwise do not occur or are not present in nature. In an embodiment, man-made objects 330 may include a bleacher, a tent, a pavilion, a TV tower, a fixture, a temporary structure, a sign, or other structure having a size and volume. In the embodiment shown in FIG. 7, man-made object 330A is shown without a covering or awning. In other embodiments, one or more of man-made objects 330 may be covered and include a covering or awning disposed above a seating area.

In an embodiment, golf hole 310 may also include people 332. In such an embodiment, people 332 may be referred to as organic matter or organic beings. People 332 may be giving off or transferring away thermal energy in the form of breath or heat emitted from the skin. Additionally, or alternatively, one or more steps of methods 100 or 200 may include measuring, sensing, and/or detecting an amount of thermal energy given off of one of man-made objects 330 (e.g., such as off of a top or covering of a bleacher, stand, or seating area due to exposure to sunlight throughout the day), people 332, bunker 320, or a combination thereof. A presence or an amount of thermal energy given off of one of man-made objects 330, people 332, bunker 320, or a combination thereof may be detected or sensed with a thermal energy measurement device such as thermography, an infrared sensing device, a thermal imaging camera, or a combination thereof. Such detection, measurement, or estimation of thermal energy present in golf hole 310 (e.g., the physical terrain from methods 100 and 200) can be taken into account into any one or more steps of methods 100 and/or 200 discussed above.

In this embodiment, people 332 are located in or on one of man-made objects 330. Additionally, or alternatively, one or more groups of people 332 may be located in one or more of man-made objects 330, on other areas/portions of golf hole 310, or a combination thereof.

In an embodiment, man-made objects 330 may define nozzle 334 extending between two adjacent man-made objects 330. For example, a relative angle formed by a side-wall of first man-made object 330A with a side-wall of second man-made object 330B is a non-zero angle and such that nozzle 334 forms a constricted section or choke point. Due to nozzle 334, natural wind 336 that passes between first man-made object 330A and second man-made object 330B is accelerated as natural wind 336 squeezes through nozzle 334. The acceleration of natural wind 336 through nozzle 334 is depicted by the length of the arrowhead representing accelerated wind 338. In other examples, one or more nozzles 34 may be formed by any of the other structures (e.g., natural or man-made) throughout golf hole 310

FIG. 7 also shows golf hole 310 as including aiming beacon 340. In this embodiment, aiming beacon 340 can be a virtual aiming beacon as discussed with respect to method 200 above. For example, if a golfer were to take dead aim at pin 318, accelerated wind 338 may push the golfer's shot into water 322. With the benefit of aiming beacon 340 providing an adjusted aim point based on the estimated effects, calculated effects, predicted effects, or a combination thereof of the wind (e.g., natural wind 336 and accelerated wind 338) on the golf ball, the golfer can adjust his or her aim to account for the effects of the wind and produce a golf shot that stays dry and ends up close to pin 318.

Regarding method 100, method 200, or any combination thereof, golf hole 310 may be the physical terrain, where any of tee boxes 312, fairway 314, green 316, pin 318, bunker 320, water 322, trees 324, man-made objects 330, people 332, or a combination thereof may be the physical feature.

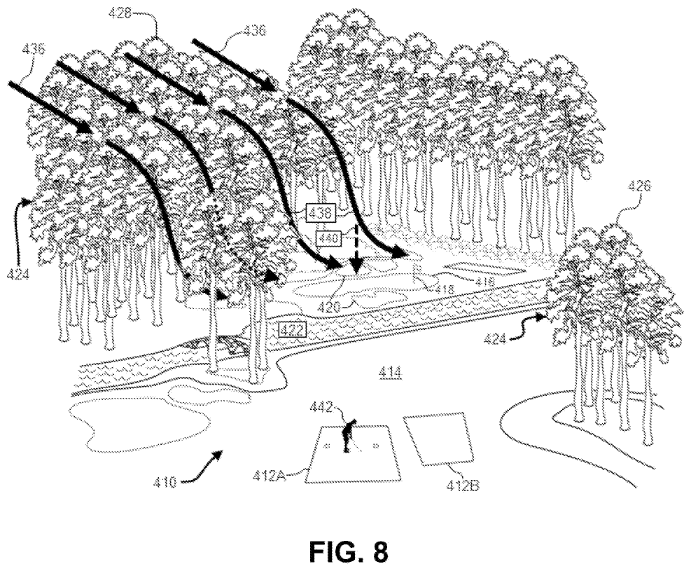

Referring now to FIG. 8, FIG. 8 is a perspective down the line view of golf hole 410 with golfer 411 preparing to hit a golf shot.

Golf hole 410 is analogous in most respects to golf hole 310 of FIG. 7, and to indicate corresponding aspects, the reference numerals have been indexed by 100 and may not be further mentioned or described with respect to FIG. 8. For example, FIG. 8 shows golf hole 410 as including tee boxes 412A and 412B, fairway 414, green 416, pin 418, bunkers 420, water 422, trees 424 (with first group 426 and second group 428), natural wind 436, accelerated wind 438, and aiming beacon 440. FIG. 8 also includes golfer 442.

In this embodiment, golfer 442 is preparing to hit a golf shot from tee box 412A with the intention of hitting his/her golf ball close to pin 418. As can be seen by the arrowheads depicting natural wind 436 and accelerated wind 438, as natural wind 436 flows across and pours over an edge or shelf of second group 428 of trees 424, a contour of second group 428 of trees 424 causes natural wind 436 to fall down from and off of second group 428 of trees 424. In this way, natural wind 436 is accelerated in a downwards direction creating accelerated wind 438. As accelerated wind 438 flows downward from second group 428 of trees 424 and across green 416, surrounding air, air flows, and wind is pulled along with accelerated wind 438 causing air currents in proximity to green 416 in a similarly downward direction. In response to this downward direction of accelerated wind 438 and the effect of accelerated wind 438 on surrounding air currents, a golf ball flying through the air will experience a downward aerodynamic force on the golf ball that is greater than a downward force natural wind 436 would apply to the golf ball during the golf shot.

Additionally or alternatively, natural wind 436, accelerated wind 438, or a combination thereof may be into the face of golfer 442 or blowing away from golfer 442 at an angle. For example, as shown in FIG. 8, both natural wind 436 and accelerated wind 438 are directed partially towards golfer 442 such that the direction of natural wind 436 and accelerated wind 438 are not only blowing perpendicular (e.g., from left-to-right as shown in FIG. 8), but are blowing partially into the face of golfer 442 as well.

In other embodiments, a direction of natural wind 436, a direction of accelerated wind 438, or a combination thereof may be aligned parallel (e.g., downwind or into-the-wind) or perpendicular (e.g., cross-wind) to an imaginary line extending from one of tee boxes 412A or 412B to green 416 (e.g., to pin 418).

As discussed above with respect to method 100 and 200, the effects of physical features (e.g., trees 424) on wind flow patterns can be predicted, calculated, or a combination thereof in order to predict how a golf shot will fly in response to the altered wind flow patterns. In this way, golfer 442 can better direct his aim in response to the causal effects of accelerated wind 438 (in addition the any effects from natural wind 436) to better account for how the flight of his/her golf shot will change. In so doing, golfer 442 will be more informed and will be better able to choose an aim point (e.g., displayed in FIG. 8 by aiming beacon 440) that will result in his/her golf shot staying out of trouble (e.g., out of bunkers 420, out of water 422, etc.) thereby finishing closer to the hole in which pin 418 is disposed, and (hopefully) resulting in a better score on golf hole 410, which can be especially important on a Sunday.

The foregoing disclosure provides illustration and description but is not intended to be exhaustive or to limit the implementations to the precise forms disclosed. Modifications and variations may be made in light of the above disclosure or may be acquired from practice of the implementations.

Even though particular combinations of features may be recited in the claim and/or disclosed in the specification, these combinations are not intended to limit the disclosure of various implementations. In fact, many of these features may be combined in ways not specifically recited in the claim and/or disclosed in the specification.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Discussion of Possible Embodiments

The following are non-exclusive descriptions of possible embodiments of the present invention.

A method of predicting wind behavior across a physical terrain includes scanning an area of the physical terrain with a sensor. A contour of the physical terrain is detected with the sensor. A presence of a physical feature on the physical terrain is detected with the sensor. A first data set representative of the physical terrain with the physical feature is created with a processing system based on the scanned area and the detected contour of the physical terrain. The first data set is converted into a null terrain. The null terrain includes a three-dimensional digital model of the physical terrain and a three-dimensional digital model of the physical feature. A flow of air through the null terrain is predictively modelled with the processing system. The flow of air includes a wind speed and a wind direction. Changes of the wind speed, the wind direction, or a combination thereof of the flow of air is calculated with the processing system based on the predictive modeling of the wind speed and the wind direction through the null terrain. An output data set of predicted wind behavior is generated based on the calculated changes of wind speed, wind direction, or a combination thereof of the flow of air through the null terrain.

The method of the preceding paragraph can optionally include, additionally and/or alternatively, any one or more of the following steps, features, configurations and/or additional components.

Predictive modeling the flow of air through the null terrain may comprise simulating the flow of air through the three-dimensional digital model of the physical terrain and the physical feature.

Simulating the flow of air through the three-dimensional digital model may comprise numerically predicting a velocity field, a pressure field, or a combination thereof of the flow of air through the three-dimensional digital model of the physical terrain and the physical feature.

Numerically predicting the velocity field, the pressure field, or the combination thereof of the flow of air may comprise performing a numerical analysis of the simulated flow of air with a reynolds stress model turbulence modelling equation, a reynolds-averaged navier-stokes equation, or a combination thereof based upon a set of inputs, wherein the set of inputs may comprise a temperature, a barometric pressure, a density, a humidity, a viscosity, or a combination thereof of the air.

Simulating the flow of air through the three-dimensional digital model may comprise performing a computational flow dynamics simulation of the flow of air flowing through the three-dimensional digital model of the physical terrain and the physical feature.

Performing the computational flow dynamics simulation may comprise: entering the wind direction and the wind speed into a reynolds stress model turbulence modelling equation, a reynolds-averaged navier-stokes equation, or a combination thereof; calculating, with the processing system, a first flow path of air through the three-dimensional digital model of the physical terrain; adjusting the reynolds stress model turbulence modelling equation, the reynolds-averaged navier-stokes equation, or the combination thereof to account for the presence of the three-dimensional digital model of the physical feature; calculating, with the processing system, a second flow path of air around the three-dimensional digital model of the physical feature; and calculating, with the processing system, an amount of deviation between the first flow path of air and the second flow path of air.

The physical feature may comprise a tree and/or the method may further comprise: determining a type, a size, a shape, a height, a volume, or a combination thereof of the tree; and determining a drag coefficient of the tree based on the type, the size, the shape, the height, the volume, or the combination thereof of the tree, wherein the first data set may comprise the drag coefficient of the tree, wherein calculating the changes of the wind speed, the wind direction, or the combination thereof of the flow of air may comprise calculating the changes of the wind speed, the wind direction, or the combination thereof based on the determined drag coefficient of the tree.

The physical feature may comprise a tree, the method may further comprise: determining a density, a leaf area index, a leaf density index, or a combination thereof of the tree; and determining a drag coefficient of the tree based on the density, the leaf area index, the leaf density index, or the combination thereof of the tree, wherein the first data set may comprise the drag coefficient of the tree, wherein calculating the changes of the wind speed, the wind direction, or the combination thereof of the flow of air may comprise calculating the changes of the wind speed, the wind direction, or the combination thereof based on the determined drag coefficient of the tree.

The physical feature may comprise a tree and/or the method may further comprise: determining a type, a size, a shape, a height, a volume, or a combination thereof of the tree, wherein calculating changes of the wind speed, the wind direction, or a combination thereof of the flow of air may comprise: determining a drag coefficient of the tree based on the type, the size, the shape, the height, the volume, or the combination thereof of the tree; and adjusting the output data set of predicted wind behavior based on the drag coefficient of the tree.

The physical feature may comprise a tree and/or the method may further comprise: determining a density, a leaf area index, a leaf density index, or a combination thereof of the tree, wherein calculating changes of the wind speed, the wind direction, or a combination thereof of the flow of air may comprise: determining a drag coefficient of the tree based on the density, the leaf area index, the leaf density index, or the combination thereof of the tree; and adjusting the output data set of predicted wind behavior based on the drag coefficient of the tree.

An effect of wind behavior on a flight-path of a golf ball may be predicted based on the output data set of predicted wind behavior.

The effect of the wind on the flight path of the golf ball may be calculated with the processing system.

A first flight-path of the golf ball through the null terrain may be estimated, the first flight path with a first starting point and a first landing point, wherein the first flight path of the golf ball may be estimated without an effect of wind on the golf ball; a second flight path of the golf ball through the null terrain may be estimated, the second flight path with a second starting point and a second landing point, wherein the second flight path of the golf ball may be estimated with an effect of wind on the golf ball; a difference between the first flight path and the second flight path may be calculated; a distance between the first landing point of the first flight path and the second landing point of the second flight path may be determined; and/or the distance between the first landing point of the first flight path and the second landing point of the second flight path may be output to a user.

The wind speed may comprise a variable wind speed based on a location, a time, or a combination thereof of the physical terrain, wherein the wind direction may comprise a variable wind direction dependent on a location, a time, or a combination thereof of the physical terrain.

A method of predicting effects of wind on a golf ball includes creating a three-dimensional model of a terrain that includes a physical feature. A wind speed, a wind direction or a combination thereof of an airflow is predictively modelled with a processing system onto the three-dimensional model of the terrain. The three-dimensional model of the terrain includes a three-dimensional model of the physical feature. The predictive modelling includes simulating a flow path of the airflow flowing through the three-dimensional model of the terrain and determining an amount of change in the simulated flow path of the airflow caused by the three-dimensional model of the physical feature. A flight path of the golf ball in the three-dimensional model of the terrain is simulated based on the determined amount of change in the simulated flow path of the airflow. A change in the flight path of the golf ball in response to the simulated flow path of the airflow through the three-dimensional model of the terrain is simulated. A data set representative of the change in the flight path of the golf ball is output.

The method of the preceding paragraph can optionally include, additionally and/or alternatively, any one or more of the following steps, features, configurations, steps and/or additional components.

A visual representation of the data set representative of the change in the flight of the golf ball can be created.

The visual representation of the data set representative of the change in the flight of the golf ball can be communicated to a user.

Creating the visual representation of the data set representative of the change in the flight of the golf ball comprises displaying a streamline corresponding to a predicted flow path of air across the physical terrain.

Creating the visual representation of the data set representative of the change in the flight of the golf ball comprises creating an array of visual indicators, wherein each indicator of the array of indicators includes a visual characteristic corresponding to a physical attribute of the airflow at a location in space.

The physical attribute of the airflow comprises a direction, a speed, a velocity, or a combination thereof of the airflow.

Simulating the flight path of the golf ball in the three-dimensional model of the physical terrain comprises simulating the flight path of the golf ball based on a set of initial flight characteristics of the golf ball.

The set of initial flight characteristics of the golf ball based on a shot profile of a user, on an attribute of a point location of the physical terrain, or on a combination thereof can be predicted.

The attribute of the point location of the physical terrain comprises a type of ground condition, a type of grass, a length of grass, an amount of moisture, an amount of slope, or a combination thereof of the point location.

The shot profile of the user comprises a flight characteristic of the golf ball, a swing speed of the user, a clubhead speed of a golf club swung by the user, a launch angle of the golf ball, a loft of a golf club, or a combination thereof.

The swing speed of the user comprises a set of swing speed values, with each swing speed value of the set of swing speed values being associated with a different golf club.

The clubhead speed of a golf club swung by the user comprises a set of clubhead speed values, with each clubhead speed value of the set of clubhead speed values being associated with a different golf club.

The launch angle of the golf ball comprises a set of launch angle values, with each launch angle value of the set of launch values being associated with a different golf club.

The physical feature comprises a tree, the method further comprising: determining a type, a size, a shape, a height, a volume, or a combination thereof of the tree; and determining a drag coefficient of the tree based on the type, the size, the shape, the height, the volume, or the combination thereof of the tree, wherein calculating the changes of the wind speed, the wind direction, or the combination thereof of the flow of air comprises calculating the changes of the wind speed, the wind direction, or the combination thereof based on the determined drag coefficient of the tree.

The physical feature comprises a tree, the method further comprising: determining a density, a leaf area index, a leaf density index, or a combination thereof of the tree; and determining a drag coefficient of the tree based on the density, the leaf area index, the leaf density index, or the combination thereof of the tree, wherein calculating the changes of the wind speed, the wind direction, or the combination thereof of the flow of air comprises calculating the changes of the wind speed, the wind direction, or the combination thereof based on the determined drag coefficient of the tree.

The physical feature comprises a tree, the method further comprising: determining a type, a size, a shape, a height, a volume, or a combination thereof of the tree, wherein calculating changes of the wind speed, the wind direction, or a combination thereof of the flow of air comprises: determining a drag coefficient of the tree based on the type, the size, the shape, the height, the volume, or the combination thereof of the tree; and adjusting the output data set of predicted wind behavior based on the drag coefficient of the tree.

The physical feature comprises a tree, the method further comprising: determining a density, a leaf area index, a leaf density index, or a combination thereof of the tree, wherein calculating changes of the wind speed, the wind direction, or a combination thereof of the flow of air comprises: determining a drag coefficient of the tree based on the density, the leaf area index, the leaf density index, or the combination thereof of the tree; and adjusting the output data set of predicted wind behavior based on the drag coefficient of the tree.

The physical feature comprises a man-made object.

A method of determining an effect of wind on a flight path of a golf ball includes predictive modeling a flow of air through a null terrain with a processing system. The null terrain includes a three-dimensional digital model of a physical terrain and a three-dimensional digital model of a physical feature. Changes of a wind speed, a wind direction, or a combination thereof of the flow of air are calculated with the processing system based on the predictive modeling of the wind speed and the wind direction through the null terrain. An output data set of predicted wind behavior is generated based on the calculated changes of wind speed, wind direction, or a combination thereof of the flow of air through the null terrain. An effect of wind behavior on the flight-path of the golf ball is predicted based on the output data set of predicted wind behavior. The effect of the wind on the flight path of the golf ball is calculated with the processing system.

The method of the preceding paragraph can optionally include, additionally and/or alternatively, any one or more of the following steps, features, configurations, steps, and/or additional components.

Calculating the effect of the wind on the flight path of the golf ball comprises: estimating a first flight-path of the golf ball through the null terrain, the first flight path with a first starting point and a first landing point, wherein the first flight path of the golf ball is estimated without an effect of wind on the golf ball; estimating a second flight path of the golf ball through the null terrain, the second flight path with a second starting point and a second landing point, wherein the second flight path of the golf ball is estimated with an effect of wind on the golf ball; calculating a difference between the first flight path and the second flight path; determining a distance between the first landing point of the first flight path and the second landing point of the second flight path; and outputting the distance between the first landing point of the first flight path and the second landing point of the second flight path to a user.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

I claim:

1. A method of predicting wind behavior across a physical terrain, the method comprising:
scanning, with a sensor, an area of the physical terrain;
detecting, with the sensor, a contour of the physical terrain;
detecting, with the sensor, a presence of a physical feature on the physical terrain;
creating, with a processing system, a first data set representative of the physical terrain with the physical feature based on the scanned area and the detected contour of the physical terrain;
converting, with the processing system, the first data set into a null terrain, wherein the null terrain comprises a three-dimensional digital model of the physical terrain and a three-dimensional digital model of the physical feature;
predictive modeling, with the processing system, a flow of air through the null terrain, the flow of air with a wind speed and a wind direction;
calculating, with the processing system, changes of the wind speed, the wind direction, or a combination thereof of the flow of air based on the predictive modeling of the wind speed and the wind direction through the null terrain; and
generating an output data set of predicted wind behavior based on the calculated changes of wind speed, wind direction, or a combination thereof of the flow of air through the null terrain.

2. The method of claim 1, wherein predictive modeling the flow of air through the null terrain comprises simulating the flow of air through the three-dimensional digital model of the physical terrain and the physical feature.

3. The method of claim 2, wherein simulating the flow of air through the three-dimensional digital model comprises numerically predicting a velocity field, a pressure field, or a combination thereof of the flow of air through the three-dimensional digital model of the physical terrain and the physical feature.

4. The method of claim 3, wherein numerically predicting the velocity field, the pressure field, or the combination thereof of the flow of air comprises performing a numerical analysis of the simulated flow of air with a reynolds stress model turbulence modelling equation, a reynolds-averaged navier-stokes equation, or a combination thereof based upon a set of inputs, wherein the set of inputs comprises a temperature, a barometric pressure, a density, a humidity, a viscosity, or a combination thereof of the air.

5. The method of claim 2, wherein simulating the flow of air through the three-dimensional digital model comprises performing a computational flow dynamics simulation of the flow of air flowing through the three-dimensional digital model of the physical terrain and the physical feature.

6. The method of claim 5, wherein performing the computational flow dynamics simulation comprises:
entering the wind direction and the wind speed into a reynolds stress model turbulence modelling equation, a reynolds-averaged navier-stokes equation, or a combination thereof;
calculating, with the processing system, a first flow path of air through the three-dimensional digital model of the physical terrain;
adjusting the reynolds stress model turbulence modelling equation, the reynolds-averaged navier-stokes equation, or the combination thereof to account for the presence of the three-dimensional digital model of the physical feature;
calculating, with the processing system, a second flow path of air around the three-dimensional digital model of the physical feature; and
calculating, with the processing system, an amount of deviation between the first flow path of air and the second flow path of air.

7. The method of claim 1, wherein the physical feature comprises a tree, the method further comprising:
determining a type, a size, a shape, a height, a volume, or a combination thereof of the tree; and
determining a drag coefficient of the tree based on the type, the size, the shape, the height, the volume, or the combination thereof of the tree,
wherein the first data set comprises the drag coefficient of the tree,
wherein calculating the changes of the wind speed, the wind direction, or the combination thereof of the flow of air comprises calculating the changes of the wind speed, the wind direction, or the combination thereof based on the determined drag coefficient of the tree.

8. The method of claim 1, wherein the physical feature comprises a tree, the method further comprising:
determining a density, a leaf area index, a leaf density index, or a combination thereof of the tree; and
determining a drag coefficient of the tree based on the density, the leaf area index, the leaf density index, or the combination thereof of the tree,
wherein the first data set comprises the drag coefficient of the tree,
wherein calculating the changes of the wind speed, the wind direction, or the combination thereof of the flow of air comprises calculating the changes of the wind speed, the wind direction, or the combination thereof based on the determined drag coefficient of the tree.

9. The method of claim 1, wherein the physical feature comprises a tree, the method further comprising:
determining a type, a size, a shape, a height, a volume, or a combination thereof of the tree,
wherein calculating changes of the wind speed, the wind direction, or a combination thereof of the flow of air comprises:
determining a drag coefficient of the tree based on the type, the size, the shape, the height, the volume, or the combination thereof of the tree; and
adjusting the output data set of predicted wind behavior based on the drag coefficient of the tree.

10. The method of claim 1, wherein the physical feature comprises a tree, the method further comprising:
determining a density, a leaf area index, a leaf density index, or a combination thereof of the tree,
wherein calculating changes of the wind speed, the wind direction, or a combination thereof of the flow of air comprises:
determining a drag coefficient of the tree based on the density, the leaf area index, the leaf density index, or the combination thereof of the tree; and
adjusting the output data set of predicted wind behavior based on the drag coefficient of the tree.

11. The method of claim 1, further comprising:
predicting an effect of wind behavior on a flight-path of a golf ball based on the output data set of predicted wind behavior; and
calculating, with the processing system, the effect of the wind on the flight path of the golf ball.

12. The method of claim 1, further comprising:
estimating a first flight-path of a golf ball through the null terrain, the first flight path with a first starting point and a first landing point, wherein the first flight path of the golf ball is estimated without an effect of wind on the golf ball;
estimating a second flight path of the golf ball through the null terrain, the second flight path with a second starting point and a second landing point, wherein the second flight path of the golf ball is estimated with an effect of wind on the golf ball;
calculating a difference between the first flight path and the second flight path;
determining a distance between the first landing point of the first flight path and the second landing point of the second flight path; and
outputting the distance between the first landing point of the first flight path and the second landing point of the second flight path to a user.

13. A method of predicting effects of wind on a golf ball, the method comprising:
creating a three-dimensional model of a physical terrain, wherein the physical terrain comprises a physical feature;
predictive modeling, with a processing system, a wind speed, a wind direction or a combination thereof of an airflow onto the three-dimensional model of the physical terrain, wherein the three-dimensional model of the physical terrain comprises a three-dimensional model of the physical feature, wherein predictive modelling comprises:
simulating a flow path of the airflow flowing through the three-dimensional model of the physical terrain; and
determining an amount of change in the simulated flow path of the airflow that is caused by the three-dimensional model of the physical feature;
simulating a flight path of the golf ball in the three-dimensional model of the physical terrain based on the determined amount of change in the simulated flow path of the airflow;
determining a change in the flight path of the golf ball in response to the simulated flow path of the airflow through the three-dimensional model of the physical terrain; and
outputting a data set representative of the change in the flight path of the golf ball.

14. The method of claim 13, further comprising creating a visual representation of the data set representative of the change in the flight of the golf ball.

15. The method of claim 14, wherein creating the visual representation of the data set representative of the change in the flight of the golf ball comprises displaying a streamline corresponding to a predicted flow path of air across the physical terrain.

16. The method of claim 14, wherein creating the visual representation of the data set representative of the change in the flight of the golf ball comprises creating an array of visual indicators, wherein each indicator of the array of indicators includes a visual characteristic corresponding to a physical attribute of the airflow at a location in space.

17. The method of claim 13, wherein simulating the flight path of the golf ball in the three-dimensional model of the physical terrain comprises simulating the flight path of the golf ball based on a set of initial flight characteristics of the golf ball.

18. The method of claim 17, further comprising predicting the set of initial flight characteristics of the golf ball based on a shot profile of a user, on an attribute of a point location of the physical terrain, or on a combination thereof.

19. A method of determining effects of wind on a golf ball, the method comprising:
predictive modeling, with a processing system, a flow of air through a null terrain, the flow of air with a wind speed and a wind direction, wherein the null terrain comprises a three-dimensional digital model of a physical terrain and a three-dimensional digital model of a physical feature;
calculating, with the processing system, changes of a wind speed, a wind direction, or a combination thereof of the flow of air based on the predictive modeling of the flow of air through the null terrain;
generating an output data set of predicted wind behavior based on the calculated changes of wind speed, wind direction, or a combination thereof of the flow of air through the null terrain;
predicting an effect of wind behavior on a flight-path of the golf ball based on the output data set of predicted wind behavior; and
calculating, with the processing system, the effect of the wind on the flight path of the golf ball.

20. The method of claim 19, wherein calculating the effect of the wind on the flight path of the golf ball comprises:
estimating a first flight-path of the golf ball through the null terrain, the first flight path with a first starting point and a first landing point, wherein the first flight path of the golf ball is estimated without an effect of wind on the golf ball;
estimating a second flight path of the golf ball through the null terrain, the second flight path with a second starting point and a second landing point, wherein the second flight path of the golf ball is estimated with an effect of wind on the golf ball;
calculating a difference between the first flight path and the second flight path;
determining a distance between the first landing point of the first flight path and the second landing point of the second flight path; and
outputting the distance between the first landing point of the first flight path and the second landing point of the second flight path to a user.
